(19) United States
(12) Patent Application Publication
(10) Pub. No.: US 2004/0236561 A1
(43) Pub. Date: Nov. 25, 2004

(54) Component management engine

(76) Inventors: Gary Smith, Morgantown, PA (US); David C. Fouche, Morgantown, PA (US); Vini Nair, West Chester, PA (US); Jim Barr, Madison, AL (US)

Correspondence Address: VENABLE, BAETJER, HOWARD AND CIVILETTI, LLP, P.O. BOX 34385, WASHINGTON, DC, 20043-9998, US

(21) Appl. No.: 10/442,125

(22) Filed: May 21, 2003

(51) Int. Cl. G06F 9/45

(52) U.S. Cl. 703/22

(57) ABSTRACT

A system and method that can accommodate both two-dimensional and three-dimensional workflows is provided. A single application and design environment is provided for designing and drawing in either a two-dimensional or a three-dimensional mode. The same design tools can be used by the designer to work in the two-dimensional or in the three dimensional mode, enabling the designer to choose the working environment. Also, while working in one mode, a link may be established with the other mode to maintain the components of the design in both modes synchronous with each other. Providing a single application for both two-dimensional and three-dimensional designs presents a clean, fast path to three-dimensional design for designers focused on two-dimensional design. Design professionals have a two dimensional and three-dimensional choice within one application that addresses their workflow needs.

### FIELD OF THE INVENTION

The present invention relates generally to systems and methods for managing CAD data and more particularly for managing components of a CAD design in both two-dimensional and three-dimensional workflows.

### BACKGROUND OF THE INVENTION

CAD software is well-known, and used by architects, engineers, designers, planners, and the like to create precision models and technical illustrations. It is used to create two-dimensional (2-D) drawings, maps, and three-dimensional (3-D) models. These drawings, maps, and models are stored in design files. Applications such as, e.g., MicroStation® products, which are developed by Bentley Systems, Inc., Exton, Pa. U.S.A., and AutoCAD® products, which are developed by Autodesk, Inc., San Rafael, Calif., U.S.A. are typical of such CAD software, which may be used in the Engineering, Construction, and Operations (ECO) marketplace.

A single design file will typically include one or more drawings, maps, and/or three-dimensional models. Design files typically represent two dimensional plan drawings or three-dimensional models. FIGS. 1A and 1B illustrate typical plan drawings and models, respectively, generated with CAD software. Models are created to represent or illustrate different parts of the design. For example, a model may be created for the floor plan, electrical system, and other parts of a building design. Each model, in turn, is comprised of a number of components, such as doors, windows, wiring, etc. The two dimensional representation is a graphical abstraction of the model that follows design professional standards.

Whether working in a two-dimensional or a three-dimensional environment, a typical CAD project is stored in numerous files. Each file typically contains one or more engineering models, each of which represents an engineering domain (e.g., structural, electrical, mechanical, plumbing). Moreover, each engineering model requires numerous items represented by a series of components to support the complex and precise nature of each design. In this context, the term “component” is used to mean a record containing a variable number of bytes of data arranged in a format that can be interpreted by a program. The term “component” differs from the common notion of an “object” in that each component can have a variable number of bytes, whereas the size of an object is typically defined by its class.

Each item in a model is represented by at least one component or an aggregation of components. For example, a structural drawing can include the column and beam layout for a floor plan, which are internally represented by lines, squares and rectangles and additional properties. In this example, an individual beam may be a collection of lines, squares and rectangle components. Attributes define the characteristics of a graphical entity such as a component, for example, the component's color or line width, and how the component is displayed to a user.

More and more, the use of three-dimensional models is being required in the ECO marketplace. However, many designers have worked for years using two-dimensional plan drawings and are only comfortable working in that environment. The required training and learning curve of designers to migrate to three-dimensional design is long and unproductive if they are not proficient in three-dimensional CAD design.

In order to solve this problem, applications have been proposed to allow a design professional to work in a two dimensional environment. These applications use a single set of data for both the two-dimensional and three-dimensional representation of the design. The data is simply displayed differently depending on the environment. When a designer desires to work in a two-dimensional environment, a two-dimensional plan drawing is extracted from the data for the three-dimensional model and presented to the designer. Typically, the extraction is performed by taking a digital “slice” through the three-dimensional model and applying design rules to show the design in plan view. The designer may then work on the two-dimensional plan.

Many of these prior applications suffer from the disadvantage of requiring the design to be made in the three dimensional model. When extraction is performed and changes are made to the two dimensional data, there is no way to propagate the changes back into the three dimensional model. Additionally, many three dimensional components are unified into one two-dimensional component, making the process of handling the design data unduly burdensome.

Thus, there is a need for a system and method that provides the flexibility to design in either a two-dimensional or a three dimensional environment. Synchronization between the two-dimensional and three-dimensional designs should be maintained. The system and method should allow collaboration of design team members, allowing components of the design to be passed between team members and two-dimensional and three-dimensional environments as required by the team's spontaneous workflows.

### SUMMARY OF THE INVENTION

A method for managing components of a design in different environments is provided. The method comprises receiving a selected environment as input from a user. A first representation of a component is created in the selected environment based in part on user input regarding the component. The first representation is added to a design file. A second representation for the component is created in another environment. The second representation is added to the design file.

According to another exemplary embodiment of the invention, a computer readable medium stores a first representation of a component in a first environment and a second representation of the same component in a second environment, wherein the first and second representations are independent of each other.

In another exemplary embodiment of the invention, a computer modeling system is provided. The system includes components that are represented by a first representation in a first environment and represented by a second representation in a second environment. A method of synchronizing the first and second representations is provided. A coupling relationship is defined between the first and second representations. An event occurs and effects one of the first and second representations. The type of coupling relationship between the first representation and the second representation is determined when the event occurs. The other of the representations is automatically updated to reflect the event if the representations are tightly coupled.

Further features and advantages of the invention, as well as the structure and operation of various embodiments of the invention, are described in detail below with reference to the accompanying drawings.

### BRIEF DESCRIPTION OF THE DRAWINGS

The foregoing and other features and advantages of the invention will be apparent from the following, more particular description of a preferred embodiment of the invention, as illustrated in the accompanying drawings wherein like reference numbers generally indicate identical, functionally similar, and/or structurally similar elements.

FIG. 1A is a diagram of a three-dimensional model;

FIG. 1B is a diagram of a two-dimensional plan;

FIG. 2 is a is a table illustrating various workflows according to an embodiment of the invention; and

FIG. 3 is a flowchart illustrating a method interface according to an embodiment of the invention.

### DETAILED DESCRIPTION OF AN EXEMPLARY EMBODIMENT OF THE PRESENT INVENTION

In an exemplary embodiment of the invention, a system and method that can accommodate both two-dimensional and three-dimensional workflows is provided. A single application and design environment is provided for designing and drawing in either a two-dimensional or a three-dimensional mode. The same design tools can be used by the designer to work in the two-dimensional or in the three dimensional mode, enabling the designer to choose the working environment. Also, while working in one mode, a link may be established with the other mode to maintain the components of the design in both modes synchronous with each other. Providing a single application for both two-dimensional and three-dimensional designs presents a clean, fast path to three-dimensional design for designers focused on two-dimensional design. Design professionals have a two dimensional and three-dimensional choice within one application that addresses their workflow needs. The preferred embodiment is described herein in conjunction with architectural design. However, the invention is equally applicable to other workspaces.

The method may be implemented via a software program operating in a client-server environment. The software program may be part of a CAD software program or a separate program. The software program may include portions running on the client, the server, or both. CAD programs are used to create the architectural components in the design and drawings. Architectural components include, among other things, doors, walls, windows, structural members, and HVAC components. The architectural components contain data that enables the software to persist and display the CAD graphics based on the design file type, either two or three-dimensional.

In the described embodiment of the invention, multiple physical representations for any given CAD component are used. For example, a first representation is provided for a component in a two-dimensional environment and a second representation is provided for the same component in the three-dimensional environment. The representations are completely independent of each other and self sustained. This allows changes made to a representation to be reflected in all environments that contain that component. The physical representations in different environments, being real components in the design, can be manipulated using all the existing tools in the CAD system. All the physical representations for any given component may have unidirectional or bi-directional connections such that any interaction with a representation is reflected across all the environments. The use of multiple representations provides a robust application with all the functionality of the design program available to the designer and the flexibility for a designer to work in their choice of a two-dimensional or three-dimensional environment.

The multiple representations created for a component depend on the component's context and environment. The multiple physical representations that are complete, self-sustained and independent components are made possible by having a ‘recipe’ for the component and a ‘recipe’ for the environment. The ‘component recipe’ is a set of instructions that is used to completely define any particular component. The component recipe may include the start point, end point, sweep direction, thickness, height, and symbology along with other information about the component that is not discussed here for clarity.

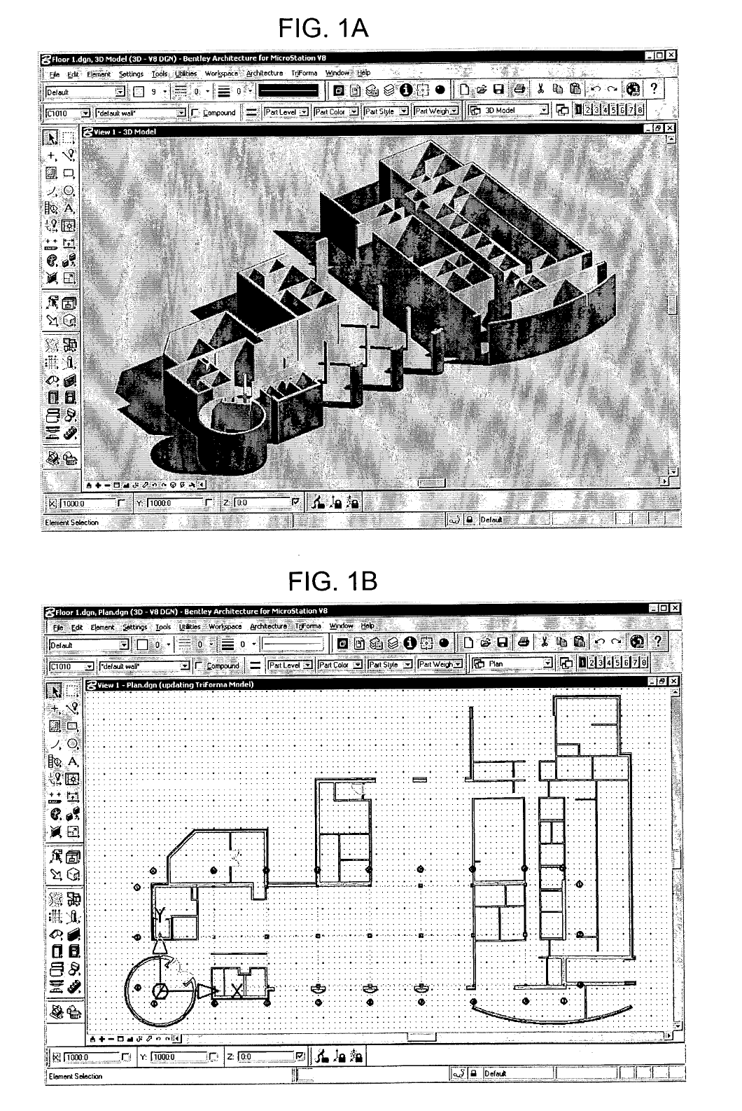

The ‘environment recipe’ defines the environment where the component resides, e.g. its context. Many different types of environments are possible. In a typically design application, there are two basic types of environments, the master model and the document model. The master model is a three-dimensional geometrical representation, akin to the real-world size and shape of the component, while the document model is a two-dimensional graphic abstraction that follows design profession standards. Examples of a master model and document model are shown in FIGS. 1A and 1B, respectively.

In the described embodiment, the master model is where the default representation is displayed, while the document model displays how the user defines it representation based on the settings in the Drawing Extraction Manager (DEM). The user while in the master model defines the document environment using the DEM. One master model may have an unlimited number of document definitions, each definition is then used to generate a document model and a copy of its definition is stored in the document model. This stored definition is used when setting up the environment.

The provision of the component recipe and the environment recipe allow each component to survive by itself in multiple environments that interact with each other and to reflect changes made to the components across the multiple environments. The physical representations for any given component may have unidirectional or bi-directional connections such that any interaction is reflected across all the environments. The connection between representations may be defined by a user and is termed herein “coupling”.

The coupling of components may have three states, highly coupled, loosely coupled, and not coupled at all. Coupling between representations allows a master-slave or peer-peer relationship leading to the unidirectional or bi-directional connection. The coupling between the physical representations defines whether the changes made to a component and the interactions between other components are reflected across all the environments. The coupling is achieved with a mapping system, described below, that allows all the physical representations for any given component to be derived. A highly coupled component is maintained in all the environments and kept up to date as modifications are made to the component. A loosely coupled representation is only kept up to date in the current environment. Upon request of the user, changes made to the component are propagated to the other environments. When the component is not coupled at all, there is only one instance of that component, that of the current environment. The state of coupling may change at any time by the request of the user. However, once coupled, a component may only switch between the highly coupled and loosely coupled state, since a representation of that component exists in another environment. Loosely coupled and not coupled is basically the same thing except that the loosely coupled component has a master-slave or peer-peer relationship, although the relationship is not active.

A ‘reactor’ is a process that happens when a particular event occurs. A program may register or unregister interest in an event. An example of an event would be when a CAD component is created or modified. These create or modify events then the call reactors that are registered for that event. An ‘environment reactor’, is a reactor as described above, but obeys the rules for that environment. Based on the environment, components are processed accordingly. In essence, coupling controls how the software handles the environment reactor states.

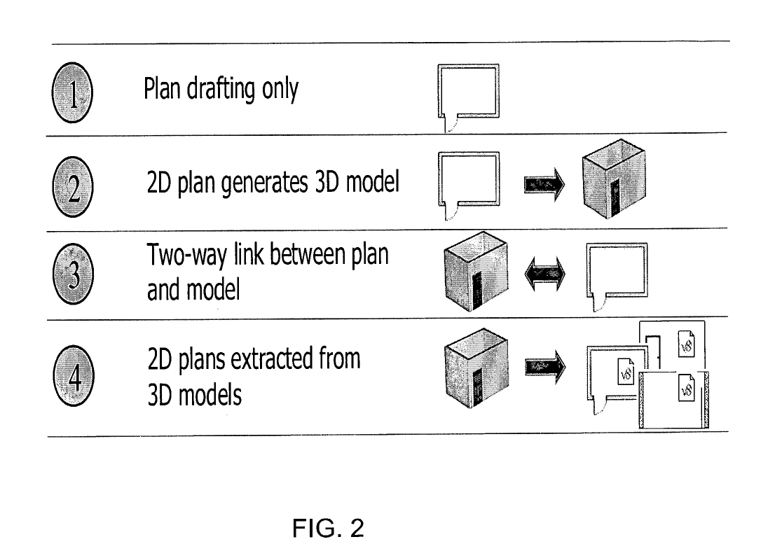

The ability of the designer to choose to work in either a two-dimensional environment or a three-dimensional environment allows for many different possible workflows available using a CAD system according to an embodiment of the invention. FIG. 2 is a table illustrating some possible workflows. In a first workflow, the designer works only in a two-dimensional environment. In this workflow, the focus is on traditional two-dimensional drafting. The designer creates a plan drawing and no corresponding model is generated. This workflow is useful when the design project does not require a model.

A second workflow is to work in the two-dimensional environment, but generate a three-dimensional model from the two-dimensional plan drawing. Here, the designer chooses to work in the two-dimensional environment. The two-dimensional plan drawing is used to dynamically generate a three-dimensional model. For example, working in the two-dimensional environment may be preferable for the inexperienced three-dimensional designer. This workflow is useful when the designer is more comfortable working with two dimensional plan drawings, but a three-dimensional model is required for the project. This workflow also allows a designer to explore and experiment with three-dimensional models, while working and designing in two dimensions.

In a third workflow, a link is provided between the two-dimensional plan drawing and the three-dimensional model, for example, through coupling as described above. This workflow allows design team members to work with either the plan drawing or the model in two-dimensions or three-dimensions. Changes made to the design while in the selected environments can be propagated to the other environment. This workflow allows for optimum collaboration between team members and design exploration.

Another possible workflow is creating the design in the three dimensional environment and extracting two-dimensional plan drawings from the three dimensional model. This workflow may be appropriate for certain points and milestones in collaborative projects.

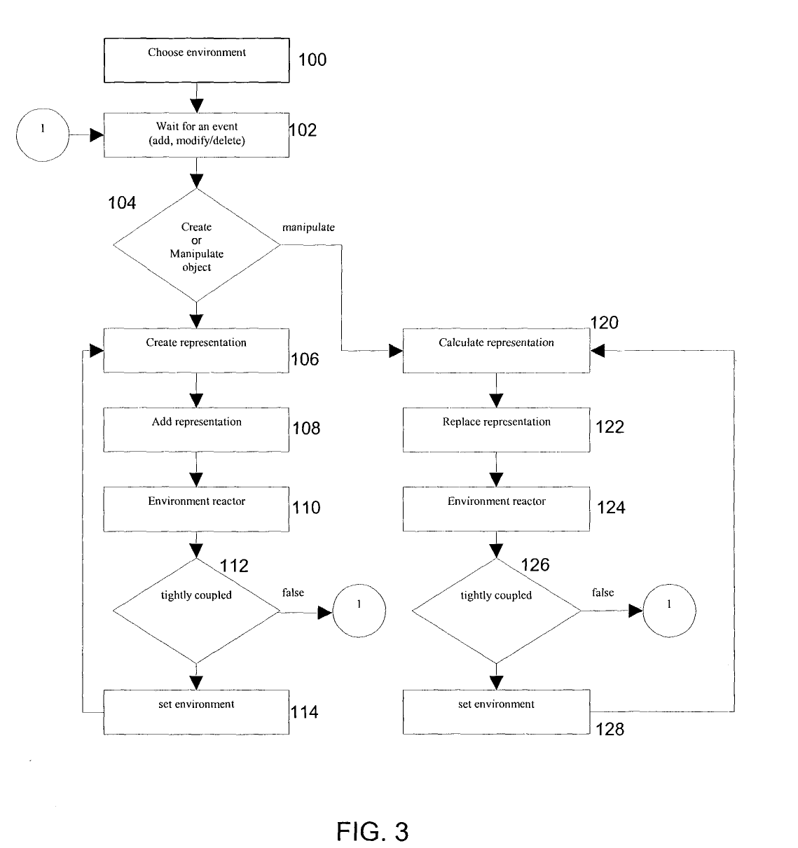

Turning now to FIG. 3, an example of a method of creating a design according to an embodiment of the invention is described in detail. The method is typically performed using software stored on a computer readable medium and operated on by a computer processor. Initially, the user is provided with a user interface via which the different functionality of a CAD program can be accessed. The user interface can take many different forms and typically includes various fields, pull down menus and the like known to one or ordinary skill in the art. The user can access existing designs or create a new design via the user interface. Once an existing design is selected or a new design begun, the user can select the environment in which they desire to work, per step 100. A seed file is provided to allow the user to choose from different environments. The seed file provides a generic file description so that the user can select the environment of their choice. The seed file includes the environment recipe that provides a default definition for the environment. For example, seed files may be provided for each of the workflows mentioned above. If the user chooses the third workflow described above, the seed file and environment recipe that provide a default definition for that workflow are used. Recall that the third workflow allows the user to choose to work in either environment. Here, assume the two-dimensional environment is selected. In the third workflow, the two-dimensional plan and the three dimensional model are linked together. Thus, when a change is made in the model, the change is reflected in the plan, and vis-versa. Accordingly, in this example the seed file includes the default environment recipe for the selected environment and defines a tightly coupled relationship between the two-dimensional and three-dimensional designs. Different environment recipes are provided for the different workflows. The user can also modify the environment recipe if desired.

The seed file also includes a definition of the reactors. The reactors are defined based on the environment and workflow selected. Upon the occurrence of certain events, the reactors are signaled and perform their specified task. Typically, the reactors are callbacks that make modifications to the representations of the components of the design. For example, if the first workflow described above is selected, there is only one representation of the components of the design. Therefore no reactors are set up. This is also the case if there is no coupling between the representations. If an environment with loose coupling is selected, the reactor propagate changes made to the representations of the current environment to other environments. This is done upon a request from the user. For example, the third workflow is selected and there is tight coupling between the representations. The events of interest in this case are the addition, modification and deletion of components to the design. When one of these events occurs, the reactor is signaled and propagates any changes made in the current environment to the representations of the component in the other environments.

Once the environment is selected and set up using the environment recipe, the user begins work on the design. As the user works with the design, the process waits for an event of interest to occur. When such an event occurs, the appropriate reactors are initiated, step 102. In this example, the events of interest include the addition, modification and deletion of components. During the design process, the user creates and/or manipulates components in the design. Step 104 determines how the process proceeds from that point. If a new component is being created, the process proceeds to step 106.

Here, a representation for the component is created by the designer. This is done in a normal fashion using CAD software. For example, the user may create a wall and place the wall in the design. A visual representation of the wall having the characteristics designated by the user is generated and displayed. As this occurs, a component recipe for the wall is created. As described above, the component recipe includes the definition of the component created by the designer. Using the component recipe, the representation of the component in the current environment is created, step 106.

Once the representation is created, it is added to the design file in step 108. For this example, the addition of a component to the design file is one of the events of interest. Therefore, the addition of the wall to the design file triggers a reactor, steps 110-112. The reactor performs its designated task based on the environment recipe. In this example, a tightly coupled relationship is defined by the environment recipe. Therefore, when the wall is created in the current environment, the reactor is a process to create and add a representation of the wall component to the other environments. Since the user selected to work in the two-dimensional environment, a representation of the wall component needs to be added to the three-dimensional model. In step 114, the environment is set to be that of the three-dimensional model. The appropriate seed file and environment recipe are used to define the three-dimensional model. The environment recipe can be the default recipe or set by the user using the DEM. As described above, the environment recipe causes the appropriate reactors to be set up. In this instance, the reactor that causes the display of the three-dimensional model is turned off as the designer is working in the two-dimensional environment. The newly added wall is then regenerated in the three-dimensional environment based on its component recipe and the environment recipe. The component recipe is obtained from the two-dimensional representation. The new representation of the wall component is then added to the three-dimensional model and the process returns to step 102 to wait for another event of interest to occur. However, if it is determined in step 112 that the representations are not tightly coupled, the process returns to step 102 and waits for another event to occur.

In an alternative embodiment, once the second representation of the component is created or modified, other drawing extraction definitions are checked to determine if they should also be updated. If any are found, an environment is set up based on the drawing extraction definition and the wall is also created based on those rules and added to the corresponding environment.

The process for modifying an existing component includes many of the same steps described above for the creation of a new component. If an existing component is being modified, step 104 directs the process to step 120. When a user manipulates a component, the representation in the current environment for that component is modified to reflect the manipulation. The component recipe is also modified accordingly. The modified representation for the component is calculated, in step 120. The modified representation is then rewritten into the two-dimensional design file in step 122.

If the modification of a component is an event of interest in the selected environment, a reactor is notified and initiates its process. In this example, the environment recipe defines a tightly coupled relationship between the different environments. Therefore, per steps 124, 126, the reactor is tasked with propagating changes made to the component in the two-dimensional environment to the other environments. Steps 126-128 are substantially the same as steps 112-114 in FIG. 3 described above. In order to propagate the change to the correct representation in other environments, the corresponding representation for the modified component must be located. Therefore when a representation for a component is initially created and a representation for that component is created in another environment, a link between the corresponding representations is created. This link may be a mapping value associated with each representation. The mapping values are stored in a mapping table. The mapping table is used to locate corresponding representations of components to propagate changes made to the component to the different environments.

Thus, in the present example the reactor extracts the mapping value stored in the modified wall component. This information is used to locate the representation corresponding to the wall component in the three-dimensional model via the mapping table. The environment is set to the three-dimensional model, step 128 and the process returns to step 120. The component recipe from the two-dimensional drawing is used to rewrite the representation of the wall component in the three-dimensional environment, per steps 120, 122. The process then returns to step 104 and waits for another event to occur.

The process for deleting a component from a design file is a special case of the modification process described above.

Accordingly, a system and method for managing CAD data is provided. Separate representations for the components of a design are created and maintained for different environments. The representation is displayed based on its environment. The representations can be synchronized with each other.

The embodiments illustrated and discussed in this specification are intended only to teach those skilled in the art the best way known to the inventors to make and use the invention. Nothing in this specification should be considered as limiting the scope of the present invention. The above-described embodiments of the invention may be modified or varied, and elements added or omitted, without departing from the invention, as appreciated by those skilled in the art in light of the above teachings. It is therefore to be understood that, within the scope of the claims and their equivalents, the invention may be practiced otherwise than as specifically described. For example, the sequence of performing the steps of the methods described above may be varied as long as the above-described dependencies are maintained.

What is claimed is:

1. A method for managing components of a design in different design environments, comprising:
receiving a selected environment as input from a user;
creating a first representation of a component in the selected environment based in part on user input regarding the component;
adding the first representation to a design file;
creating a second representation for the component in another environment; and
adding the second representation to the design file.

2. The method of claim 1, wherein the first and second representations are independent from each other.

3. The method of claim 1, wherein the first representations comprises a component recipe that defines attributes of the component.

4. The method of claim 3, wherein the component recipe defines at least one of start point, end point, sweep direction, thickness, height, and symbology.

5. The method of claim 1, wherein step comprises creating the second representation based on the component recipe.

6. The method of claim 4, wherein the component recipe is included as part of the second representation.

7. The method of claim 1, wherein the selected environment is one of a two-dimensional or a three-dimensional geometric environment.

8. The method of claim 1, further comprising receiving an environmental recipe as user input.

9. The method of claim 8, wherein the enviromental recipe defines the environment the component resides in.

10. The method of claim 1, further comprising coupling the first representation with the second representation.

11. The method of claim 10, further comprising mapping the first representation to the corresponding second representation.

12. The method of claim 10, wherein the first and second representations are one of tightly coupled or loosely coupled.

13. The method of claim 10, further comprising:
waiting for a predefined event to occur to the first representation;
determining the type of coupling between the first representation and the second representation when the predefined event occurs; and
automatically updating the second representation to reflect the event if the representations are tightly coupled.

14. The method of claim 13, further comprising updating the second representation to reflect the event based on a user request if the representations are loosely coupled.

15. The method of claim 14, wherein the event comprises one of an addition, deletion, and modification of a component.

16. The method of claim 15, wherein step comprises regenerating the component in the other environment based on the component recipe.

17. The method of claim 10, further comprising receiving user input to define the coupling.

18. The method of claim 9, further comprising displaying the component based on the environment recipe and the component recipe.

19. The method of claim 1, further comprising receiving user input manipulating the component in the selected environment;
modifying the component and the component recipe to reflect the manipulation.

20. The method of claim 19, further comprising:
determining a mapping value for the first representation;
identifying the corresponding second representation based on the mapping value; and
rewriting the second representation based on the modified component recipe.

21. A computer readable medium storing a first representation of a component in a first environment and a second representation of the component in a second environment, wherein the first and second representations are independent of each other.

22. The computer readable medium of claim 21, wherein the first and the second environments are one of a two-dimensional or a three-dimensional geometric environment.

23. The computer readable medium of claim 21, wherein each representation includes a recipe for the component.

24. The computer readable medium of claim 23, wherein the component recipe includes at least one of a start point, and end point, a sweep direction, thickness, height, and symbology for the component.

25. The computer readable medium of claim 23, wherein the recipe defines attributes of the component.

26. The computer readable medium of claim 21, wherein each representation is self-contained.

27. The computer readable medium of claim 21, wherein each representation includes a coupling definition defining a relationship between the first and second environments.

28. The computer readable medium of claim 21, further comprising storing a first environmental recipe defining the first environment and a second environmental recipe defining the second environment.

29. In a computer modeling system having components represented by a first representation in a first environment and represented by a second representation in a second environment, a method of synchronizing the first and second representations, comprising:
defining a coupling relationship between the first and second representations;
waiting for an event to occur to one of the first and second representations;
determining the type of coupling relationship between the first representation and the second representation when the event occurs;
automatically updating the other of the representations to reflect the event if the representations are tightly coupled.

30. The system of claim 29, further comprising updating the second representation to reflect the event based on a user request if the representations are loosely coupled.

31. The system of claim 29, wherein the event comprises one of an addition, deletion, and modification of a component.

32. A computer readable medium storing computer readable program code for causing a computer to perform the steps of:
receiving a selected environment as input from a user;
creating a first representation of a component in the selected environment;
adding the first representation to a database;
creating a second representation for the component in another environment; and
storing the second representation in the database.

33. The computer readable medium of claim 32, wherein the first and second representations are independent from each other.

34. The computer readable medium of claim 32, wherein the first representations comprises a component recipe that defines attributes of the component.
